(19) United States
(12) Patent Application Publication
(10) Pub. No.: US 2025/0226436 A1
(43) Pub. Date: Jul. 10, 2025

(54) LI-ION BATTERY BASED SOLID ELECTROLYTE FLEXIBLE MEMBRANE

(71) Applicant: Khalifa University of Science and Technology, Abu Dhabi (AE)

(72) Inventors: Daniel CHOI, Abu Dhabi (AE); Prerna CHATURVEDI, Abu Dhabi (AE)

(21) Appl. No.: 18/850,904

(22) PCT Filed: Aug. 21, 2023
(86) PCT No.: PCT/US2023/072558

§ 371 Date: Sep. 25, 2024

Related U.S. Application Data
(60) Provisional application No. 63/399,935, filed on Aug. 22, 2022.

(51) Int. Cl. H01M 10/0525; H01M 4/02; H01M 4/36; H01M 4/485; H01M 4/58; H01M 10/0565; H01M 10/0587; H01M 50/426; H01M 50/46; H01M 50/497

(52) U.S. Cl. CPC H01M 10/0525; H01M 4/362; H01M 4/485; H01M 4/5825; H01M 10/0565; H01M 10/0587; H01M 50/426; H01M 50/46; H01M 50/497; H01M 2004/027; H01M 2004/028; H01M 2300/0082

(57) ABSTRACT

Embodiments of the present technology may include flexible all-solid-state lithium-ion batteries. The batteries may include a plurality of jelly roll battery cells. Each jelly roll battery cell may include a cathode, an anode. and a hybrid solid electrolyte membrane. The cathode may be or include a first self-supporting lithium-based composite. The anode may be or include a second self-supporting lithium-based composite. The hybrid solid electrolyte membrane may be positioned between the cathode and the anode.

### CROSS-REFERENCES TO RELATED APPLICATIONS

This application claims the benefit of U.S. Provisional Application No. 63/399,935 filed Aug. 22, 2022, the entire contents of which are hereby incorporated for all purposes in their entirety.

### BACKGROUND OF THE INVENTION

Electrochemical energy storage systems can store energy in chemical form and can be used to convert the energy to electricity. Conventional electrochemical energy storage can include batteries and electrochemical capacitors (ECs). Lithium-ion batteries can provide a high energy density, high working voltage, long cycle life and low self-discharge rate. A conventional lithium-ion battery can include an anode, a cathode, and a liquid electrolyte with a separator to prevent undesired electrical currents between the anode and cathode when a load is not connected to the lithium-ion battery. Slurry casting methods are often used for preparing and manufacturing the anode and cathode, where a mixture of active material with carbon and binder can be coated on a metal foil.

### BRIEF SUMMARY OF THE INVENTION

Embodiments of the present technology may include flexible all-solid-state lithium-ion batteries. The batteries may include a plurality of jelly roll battery cells. Each jelly roll battery cell may include a cathode, an anode, and a hybrid solid electrolyte membrane. The cathode may be or include a first self-supporting lithium-based composite. The anode may be or include a second self-supporting lithium-based composite. The hybrid solid electrolyte membrane may be positioned between the cathode and the anode.

In some embodiments, each of the cathode and the anode may further include a plurality of multi-walled carbon nanotubes. The anode may include a self-supporting lithium titanate multi-walled carbon nanotube composite. The cathode may include a self-supporting lithium iron phosphate multi-walled carbon nanotube composite. The hybrid solid electrolyte membrane may be characterized by an ionic conductivity greater than or about 0.0005 Siemens per centimeter. The hybrid solid electrolyte membrane may be characterized a thickness of less than or about 30 microns. The all-solid-state lithium-ion battery may be configured to operate without a current collector. The hybrid solid electrolyte membrane may be or include a poly(vinylidene fluoride-co-hexafluoropropylene) material.

In some embodiments, the hybrid solid electrolyte membrane can be characterized by an ionic conductivity substantially similar to 10\hat{ }-3 Siemens per centimeter. In some embodiments, the flexible all-solid-state lithium-ion battery can be configured to operate without a current collector. In some embodiments, the hybrid solid electrolyte membrane can include a poly(vinylidene fluoride-co-hexafluoropropylene) material.

Some embodiments of the present technology may encompass roll-to-roll methods of manufacturing jelly roll battery cells for flexible all-solid-state lithium-ion batteries. The methods may include depositing, on an upper side of a hybrid solid electrolyte membrane, a cathode material. The cathode material may be or include a first self-supporting lithium-based composite. The methods may include annealing the cathode material. The methods may include depositing, on a lower side of the hybrid solid electrolyte membrane, an anode material. The anode material may be or include a second self-supporting lithium-based composite. The methods may include annealing the anode material.

In some embodiments, each of the cathode material and the anode material may further include a plurality of multi-walled carbon nanotubes. The anode material may include a self-supporting lithium titanate multi-walled carbon nanotube composite. The cathode material may include a self-supporting lithium iron phosphate multi-walled carbon nanotube composite. The hybrid solid electrolyte membrane may be characterized by an ionic conductivity greater than or about 0.0005 Siemens per centimeter. The hybrid solid electrolyte membrane may be characterized by a thickness of less than or about 30 microns.

Depositing the cathode material may include directly coating a slurry of the cathode material onto the upper side of the hybrid solid electrolyte membrane. Depositing the anode material may include directly coating a slurry of the cathode material onto the lower side of the hybrid solid electrolyte membrane. The hybrid solid electrolyte membrane may be or include a poly(vinylidene fluoride-co-hexafluoropropylene) material.

Some embodiments of the present technology may encompass electrodes for all-solid-state lithium-ion batteries. The electrodes may include a self-supporting lithium-based composite that may be configured to be wet coated on a hybrid solid electrolyte membrane and annealed.

In some embodiments, the electrode may further include a plurality of multi-walled carbon nanotubes. The electrode may include at least one material selected from a group including: (i) a self-supporting lithium titanate multi-walled carbon nanotube composite, and (ii) a self-supporting lithium iron phosphate multi-walled carbon nanotube composite. The hybrid solid electrolyte membrane may be characterized by an ionic conductivity greater than or about 0.0005 Siemens per centimeter. The hybrid solid electrolyte membrane may be characterized by a thickness of less than or about 20 microns. The hybrid solid electrolyte membrane may be or include a poly(vinylidene fluoride-co-hexafluoropropylene) material.

### BRIEF DESCRIPTION OF THE DRAWINGS

FIG. 1 is an exemplary diagram of a conventional lithium-ion battery according to certain aspects of the present disclosure.

FIG. 2 is an illustration of an exemplary process that can be implemented to manufacture flexible all-solid-state lithium-ion batteries according to some examples of the present disclosure.

FIG. 3 is a flow chart of an exemplary process that can be implemented to manufacture flexible all-solid-state lithium-ion batteries according to some examples of the present disclosure.

FIG. 4A, 4B, and 4C is an illustration of exemplary component layers of a flexible all-solid-state lithium-ion battery according to some examples of the present disclosure.

FIG. 5 is an illustration of an exemplary flexible all-solid-state lithium-ion battery having a jelly roll cell configuration according to some examples of the present disclosure.

FIG. 6A, 6B, 6C, 6D, 6E, and 6F is an illustrative series of measurements that may be obtained from an exemplary flexible all-solid-state lithium-ion battery according to some examples of the present disclosure.

### DETAILED DESCRIPTION OF THE INVENTION

Growing worldwide demand for energy, scarcity, and environmental impact associated with conventional energy sources are associated with a potential for an energy crisis. Alternative renewable energy resources such as solar, wind and hydro can be utilized to overcome the issues associated with conventional energy sources. However, these renewable energy resources may not be able to supply power on demand. Hence, energy storage devices which can be coupled with renewable energy resources may be able to mitigate issues associated with both conventional energy and renewable energy.

In energy storage systems, energy can be stored in chemical form and can be converted in electrical form whenever the energy is needed. The most popular electrochemical energy storage systems include batteries and electrochemical capacitors (ECs). Among various rechargeable batteries, lithium-ion batteries (LIBs) have gained significant attention due to advantages such as high energy density, high working voltage, long cycle life and low self-discharge rate. Recently, continuous efforts have been made to improve the current lithium-ion battery technology to meet the demand for high performance, safety in various applications, such as portable appliances, implantable medical devices, smart cards, consumer electronics, smart packaging, wearable devices, electric vehicles (EVs), energy storage systems (ESS), etc. Conventional LIBs may include a lithium/carbon anode, a lithium metal oxide cathode, a separator between the anode and cathode, and a liquid electrolyte. A slurry casting method is commonly used for the preparation of electrodes for LIBs, where the mixture of active material with carbon and binder is coated on a metal foil. The active material may easily and undesirably detach from a surface of the metal foil, which may be a current collector, when bent. Hence, there is a need of light weight, flexible and current collector free electrodes.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

An all-solid-state lithium-ion battery can include a hybrid solid electrolyte membrane and a pair of electrodes. The hybrid solid electrolyte membrane may be both flexible and thin. Accordingly, the hybrid solid electrolyte membrane may reduce an amount of dead space present in the battery. The hybrid solid electrolyte membrane can enable the all-solid-state lithium-ion battery to exhibit improved mechanical properties, improved safety, and improved mechanical properties when compared to batteries with liquid electrolytes. In some examples, the hybrid solid electrolyte membrane can enable the all-solid-state lithium battery to perform at high operating temperature ranges. In addition to conducting ions between the anode and cathode, the hybrid solid electrolyte membrane can also serve as a separator between anode and cathode. That is, the hybrid solid electrolyte membrane can prevent unwanted current from flowing between the anode and cathode. The hybrid solid electrolyte membrane can have a high ionic conductivity and a negligible electronic conductivity at room temperature. Furthermore, the hybrid solid electrolyte membrane can include a wide electrochemical range, good chemical and thermal stability, high mechanical strength, and a high Li⁺ transference number. In some examples, the hybrid solid electrolyte membrane can be manufactured using roll-to-roll (R2R) processing techniques.

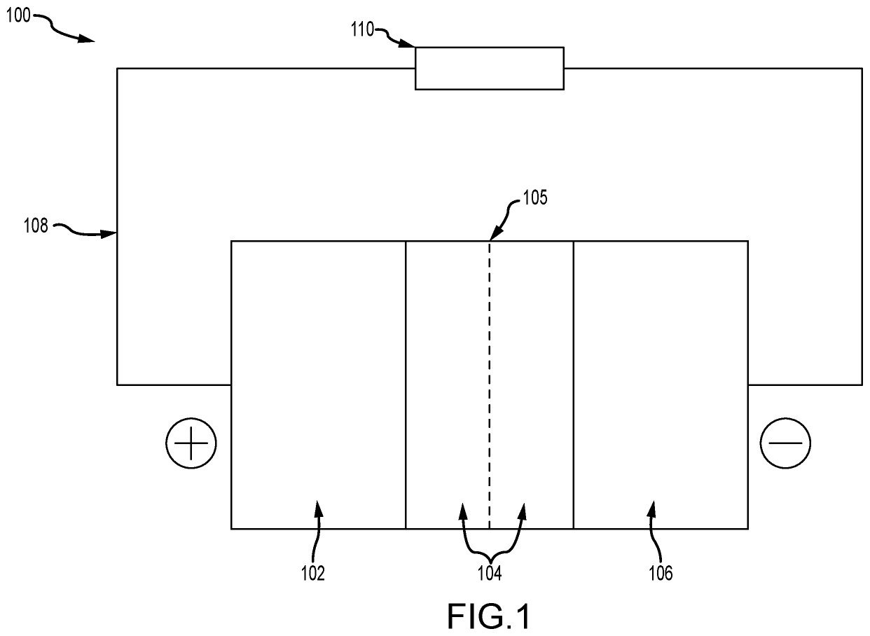

FIG. 1 is an exemplary diagram of a lithium-ion battery 100 according to certain aspects of the present disclosure. The lithium-ion battery 100 can include a cathode 102 and an anode 106 separated by an electrolyte 104. Lithium ions can flow between the anode 106 and the cathode 102 to enable an electrical current that can power a load circuit. The lithium-ion battery can be coupled to a load 110 via one or more electrical connectors 108 to enable current to flow from the anode 106 to the cathode 102, thereby powering the load 110.

In embodiments, the cathode 102 and the anode 106 may be separated by an electrolyte. In conventional technologies, the electrolyte may typically be a liquid. One common liquid electrolyte in LIBs a lithium salt solution, lithium hexafluorophosphate. Other lithium batteries use liquid electrolytes such as LiPF₆, LiBF₄, or LiClO₄, that have been mixed with an organic solvent. However, embodiments of the present technology, as further discussed below, may include a solid electrolyte instead of a liquid electrolyte.

In some LIBs, a separator 105 may also be present between the cathode 102 and the anode 106. The separator may be a polymer-based membrane that can prevent electrical contact between the anode and the cathode, thereby preventing the battery from short-circuiting. Lithium ions can pass through the separator, allowing ions to be conducted through the battery and enabling current to flow through the battery. However, separators and other components of conventional LIBs may result in the battery being rigid and inflexible.

Accordingly, stacks of conventional lithium-ion battery cells may include large regions of dead space that do not contribute to the energy density of the lithium-ion-battery. Embodiments of the present technology as further discussed below, may be configured without a separator and, therefore, may be more flexible than conventional technologies.

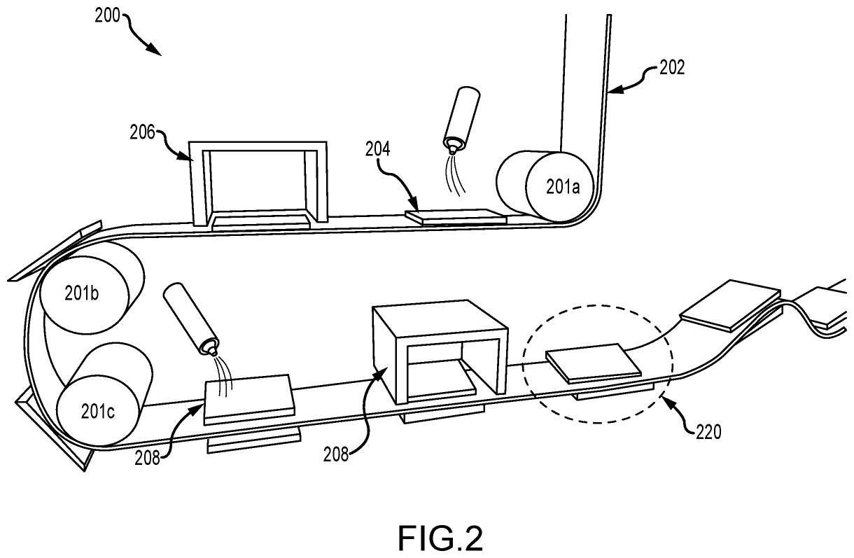

FIG. 2 is an illustration of an exemplary processing system 200 that can be implemented to manufacture flexible all-solid-state lithium-ion batteries according to some examples of the present disclosure. In some examples, the processing system 200 can be a roll-to-roll process. The roll-to-roll processing system 200 can include embedding, coating, printing, or otherwise depositing one or more materials onto a flexible rolled substrate material, such as a hybrid solid electrical membrane 202, as the material is fed continuously from one roller 201a to another, such as roller 201b or 201c.

The hybrid solid electrolyte membrane 202 can be flexible and lightweight. For example, the hybrid solid electrolyte membrane 202 may be characterized by a Young's modulus of greater than or about 7.5 MPa, and may be characterized by a Young's modulus of greater than or about 8.0 MPa, greater than or about 8.5 MPa, greater than or about 9.0 MPa, greater than or about 9.5 MPa, greater than or about 10.0 MPa, or more. A 1 cm² piece of the hybrid solid electrolyte membrane 202 with a thickness of 25 μm may additionally and/or alternatively be characterized by a weight of less than or about 10 mg, and may be characterized by a weight of less than or about 9 mg. less than or about 8 mg, less than or about 7 mg, less than or about 6 mg, less than or about 5 mg, less than or about 4 mg, or less. The hybrid solid electrolyte membrane 202 may be or include a poly(vinylidene fluoride-co-hexafluoropropylene)-based material. In one exemplary embodiment, the hybrid solid electrolyte membrane 202 may be a poly(vinylidene fluoride-co-hexafluoropropylene) (PVDF-HFP) tantalum-doped lithium lanthanum zirconium oxide (LLZO)-based material.

The hybrid solid electrolyte membrane 202 can be manufactured with a drop casting process. The drop casting process can be relatively inexpensive and can enable the hybrid solid electrolyte membrane 202 to be mass produced.

In embodiments, the hybrid solid electrolyte membrane 202 may be soaked in a liquid electrolyte solution prior to or during the roll-to-roll processing. In embodiments, the liquid electrolyte solution may be a fluorine-containing solution. For example, the hybrid solid electrolyte membrane 202 may be immersed in liquid electrolyte solution of 1.0 M LiPF₆ in equal parts of ethylene carbonate (EC) and dimethylene carbonate (DMC), or any other suitable liquid electrolyte solution. By immersing the hybrid solid electrolyte membrane 202 the fluorine-containing solution, a surface of the fluorine-containing solution may be fluorinated. Fluorinating the hybrid solid electrolyte membrane 202 may increase lithium-ion conduction on the surface and also accelerate ionic transportation. Soaking the hybrid solid electrolyte membrane 202 in the liquid electrolyte solution can also provide improved surface contact with materials that are deposited onto the hybrid solid electrolyte membrane 202.

The hybrid solid electrolyte membrane 202 may be characterized by a relatively small thickness compared to conventional membranes or separators. For example, the hybrid solid electrolyte membrane 202 may be characterized by a thickness of less than or about 30 microns and may be characterized by a thickness of less than or about 28 microns, less than or about 26 microns, less than or about 24 microns, less than or about 22 microns, less than or about 20 microns, or less. In embodiments, the hybrid solid electrolyte membrane 202 may be characterized by a thickness between about 15 microns and about 20 microns.

The uniform distribution of electrolytes in the hybrid solid electrolyte membrane 202 can improve the ionic conductivity and reduce the interfacial resistance of the hybrid solid electrolyte membrane 202. In embodiments, the hybrid solid electrolyte membrane 202 may be characterized by an ionic conductivity that is similar to a liquid electrolyte. For example, the hybrid solid electrolyte membrane may be characterized by an ionic conductivity of greater than or about 0.0005 Siemens per centimeter (S/cm) at room temperature, such as greater than or about 0.0001 S/cm, or more. In some examples, the hybrid solid electrical membrane can exhibit roughly a 69% contribution of lithium-ion conduction to total conductivity. That is, about 69% of the total conductivity of the hybrid solid electrolyte membrane can be due to lithium-ion conduction.

In some examples, inorganic filler materials can be incorporated into the hybrid solid electrolyte membrane 202. The inorganic fillers may provide freely movable active Li⁺ ions and an additional Li⁺ conductive channel. In embodiments. the inorganic fillers can be ionic conductors (such as Li_{1.3}Al_{0.3}Ti_{1.7}(PO₄)₃ (LATP)), inert ceramic fillers (such as Al₂O₃, SiO₂, or TiO₂), garnet-based LLZO materials Li_{0.33}La_{0.557}TiO₃ (LLTO), Li₆PS₅Cl, and Li₁₀GeP₂S₁₂ (LGPS). Additionally, due to the high electrochemical stability of lithium-containing inorganic fillers, such as LLZO-based materials, and their interactions with polymers, the hybrid solid electrolyte membrane 202 can exhibit a wider electrochemical stability window, higher mechanical strength, and better thermal stability when inorganic fillers are included in the hybrid solid electrolyte membrane 202.

In embodiments, the hybrid solid electrolyte membrane 202 can function as an electrolyte separator. That is, the hybrid solid electrolyte membrane 202 can be coupled to an anode and a cathode and can prevent unwanted electrical contact between the anode and the cathode. Since the hybrid solid electrolyte membrane 202 can prevent unwanted electrical contact between the anode and the cathode, the hybrid solid electrolyte membrane 202 can operate without requiring an additional separator.

In some examples, a PVDF-HFP based hybrid solid electrolyte membrane 202 can be prepared by mixing PVDF-HFP, a lithium salt (e.g., lithium bis (trifluoromethanesulfonyl) imide (LiTFSI)), and tantalum-doped LLZO with dimethylformamide (DMF). After mixing. the solution can be cast in a mold and dried in a vacuum. In some embodiments, the solution can be vacuum-dried at 60° C. The morphological, physical, and electrochemical properties of the hybrid solid electrolyte membrane 202 can be characterized by using Field Emission Scanning Electron Microscopy (FESEM), X-ray Powder Diffractometry (XRD), electrochemical impedance spectroscopy

(EIS), and/or chronoamperometry.

The processing system 200 can deposit a cathode material 204 onto the hybrid solid electrolyte membrane 202. The cathode material 204 can include a self-supporting lithium-based composite. The self-supporting lithium-based composite can be assembled without requiring any additional structural material, such as polymeric binders or conductive additives. The self-supporting nature may increase the energy density of the all-solid-state lithium-ion battery 220. Additionally, the self-supporting lithium-based composite can be self-assembling. For example, the cathode material 204 can include a lithium iron phosphate composite, such as a self-supporting lithium iron phosphate titanate multiwalled carbon nanotube-based composite. In some examples, depositing the cathode material 204 onto the hybrid solid electrolyte membrane 202 can involve coating a first surface or first portion of the hybrid solid electrolyte membrane 202 with a slurry of the cathode material 204. In some examples, the cathode material 204 can be deposited on an upper surface of the hybrid solid electrical membrane 202, on a lower surface of the hybrid solid electrical membrane 202, on a side portion of the hybrid solid electrical membrane 202, or any combination thereof.

Additionally, the cathode material 204 that has been deposited onto the hybrid solid electrolyte membrane 202 can be annealed and/or cured in an oven 206 or any other suitable heating apparatus. In some examples, the cathode material 204 can be heated to greater than or about 90 degrees Celsius, greater than or about 100 degrees Celsius, greater than or about 110 degrees Celsius, greater than or about 120 degrees Celsius, greater than or about 130 degrees Celsius, or any other suitable annealing temperature. The cathode material 204 can be heated for any suitable amount of time, such as between 5 and 10 minutes, between 10 and 15 minutes, between 15 and 30 minutes, and between 30 minutes and one hour in ambient conditions.

The processing system 200 deposit an anode material 208 onto the hybrid solid electrical membrane 202. The anode material 208 can include a lithium titanate-based composite, such as a self-supporting lithium titanate multi-walled carbon nanotube-based composite. The self-supporting lithium titanate multi-walled carbon nanotube-based composite can be assembled without requiring any additional structural material, such as polymeric binders or conductive additives. The self-supporting nature may increase the energy density of the all-solid-state lithium-ion battery 220. Additionally, the self-supporting lithium titanate multi-walled carbon nanotube-based composite can be self-assembling. The anode material 208 can be deposited on an opposite side of the hybrid solid electrolyte membrane 202 with respect to the cathode material 204. In some examples, depositing the anode material 208 onto the hybrid solid electrolyte membrane 202 can involve coating a second surface or second portion of the hybrid solid electrolyte membrane 202 with a slurry of anode material 208. The second surface or second portion of the hybrid solid electrolyte membrane 202 may be opposite the first surface or first portion. In some examples, the anode material 208 can be deposited on the hybrid solid electrolyte membrane 202 before the cathode material 204 is deposited, after the cathode material 204 is deposited, or the anode material 208 can be deposited simultaneously with the cathode material 204. The anode material 208 that has been deposited on the hybrid solid electrolyte membrane 202 can be annealed or cured to generate the all-solid-state lithium-ion battery 220. In some examples, the anode material 208 can be heated to greater than or about 90 degrees Celsius, greater than or about 100 degrees Celsius, greater than or about 110 degrees Celsius, greater than or about 120 degrees Celsius, greater than or about 130 degrees Celsius, or any other suitable annealing temperature. The anode material 208 can be heated for any suitable amount of time, such as between 5 and 10 minutes, between 10 and 15 minutes, between 15 and 30minutes, and between 30 minutes and one hour in ambient conditions.

The cathode material 204 and the anode material 208 may be characterized by increased specific capacities compared to conventional materials. For example, the cathode material 204 may be characterized by a specific capacity of greater than or about 100 mAh/g, greater than or about 110 mAh/g, greater than or about 120 mAh/g, or greater than or about 130 mAh/g. The cathode material 204 can be characterized by one or more of the above specific capacities at about 0.1 current rate (C), greater than or about 0.3 C, greater than or about 0.5 C, greater than or about 1 C, or greater than or about 2 C. Current rate may be related to the charging rate of the battery, where 1 C represents the battery charges in 1 hours, 2 C represents the battery charges in 30 minutes. 0.5 C represents the battery charges in 2 hours, etc. Similarly, the anode material 208 may be characterized by a specific capacity of greater than or about 100 mAh/g, greater than or about 110 mAh/g, greater than or about 120 mAh/g, or greater than or about 130 mAh/g. The anode material 208 can be characterized by one or more of the above specific capacities at a current rate of about 0.1 C, greater than or about 0.3 C, greater than or about 0.5 C, greater than or about 1 C, or greater than or about 2 C.

The all-solid-state lithium-ion battery 220 can have a jelly roll configuration that can enable the fabrication of high-density jelly roll cells that can be implemented in prismatic batteries. The high-density jelly roll cells can be stacked to form a prismatic battery having small regions of dead space between the high-density jelly roll cells. Components of the all-solid-state lithium-ion battery 220 can be sufficiently flexible to decrease the sizes of the dead space regions. Additionally, a current-collector-free and/or separator-free configuration of the all-solid-state lithium-ion battery 220 can further decrease the sizes of the dead space regions. While not depicted, it is also contemplated the present embodiments may also be employed in other battery applications including, but limited to. cylindrical cells. In some examples, the jelly roll configuration can include a layer of anode material 208 on an exterior portion of the jelly roll and cathode material 204 on an interior portion of the jelly roll, the exterior portion being separated from the interior portion of the jelly roll by a layer of hybrid solid electrolyte membrane 202. Alternatively, the exterior portion can include the cathode material 204 and the interior portion can include the anode material 208.

As previously discussed, the all-solid-state lithium-ion battery 220 may be characterized by an increased flexibility compared to conventional batteries. Further, in embodiments, the all-solid-state lithium-ion battery 220 can be manufactured without a current collector and can be operable without a current collector. Accordingly, the jelly roll configuration may reduce dead space within a battery, such as a prismatic battery, by at least 20-30% with respect to a conventional lithium-ion battery. The reduced dead space can result in an increased energy density of the prismatic battery. The same volume of space in a prismatic battery can be occupied by the multiple stacks of all-solid-state lithium-ion batteries 220, which can reduce dead space compared with the jelly roll cells of the conventional lithium-ion battery. In some examples, the cathode material 204, anode material 208, and hybrid solid electrical membrane 202 can be prepared separately and later assembled together in a coin-cell configuration to form a full-cell battery.

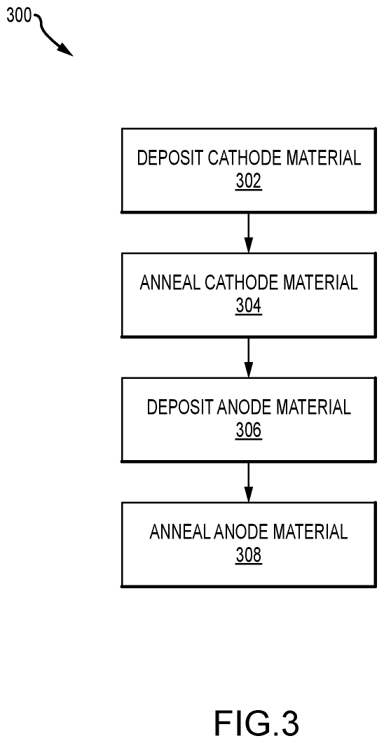

FIG. 3 is a flow chart of an exemplary process that can be implemented to manufacture flexible all-solid-state lithium-ion batteries according to some examples of the present disclosure. FIG. 3 may describe operations previously discussed with respect to the components in FIG. 2. Accordingly, any of the following operations of method 300 may include features or characteristics of processing system 200 previously with regard to FIG. 2.

Operation 302 of method 300 may include depositing, on an upper side of a hybrid solid electrolyte membrane, a cathode material having first self-supporting lithium-based composite. The cathode material can be deposited on the hybrid solid electrolyte membrane at room temperature and ambient conditions, or any other suitable temperatures and conditions.

Operation 304 of method 300 may include annealing the cathode material. For example, operation 304 of method 300 can involve annealing the cathode material at 120 degrees Celsius for 30 minutes. Annealing the anode material can cause the cathode material to dry and/or cure. In some examples, annealing the cathode material can cause the cathode material to adhere to the hybrid solid electrolyte membrane.

Operation 306 of method 300 may include depositing, on a lower side of the hybrid solid electrolyte membrane, an anode material comprising a second self-supporting lithium-based composite. The anode material can be deposited on the hybrid solid electrolyte membrane at room temperature and ambient conditions, or any other suitable temperatures and conditions. For example, the anode material can be wet coated onto the hybrid solid electrical membrane.

Operation 308 of method 300 may include annealing the anode material. For example, operation 308 of method 300 can involve annealing the anode material at 120 degrees Celsius for 30 minutes. Annealing the anode material can cause the anode material to dry and/or cure. In some examples, annealing the anode material can cause the anode material to adhere to the hybrid solid electrolyte membrane.

The order of the operations of method 300 presented in the examples above can be varied. For example, operations can be re-ordered, combined, and/or broken into sub-operations. Certain operations of method 300 may also be performed in parallel.

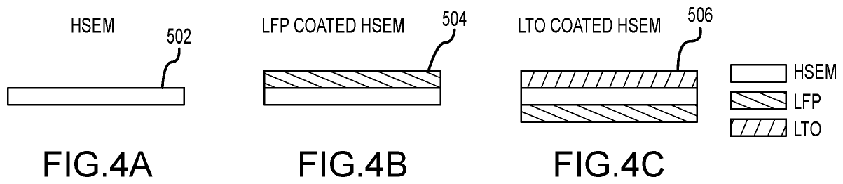

FIG. 4A-4C is an illustration of exemplary component layers of a flexible all-solid-state lithium-ion battery according to some examples of the present disclosure. The all-solid-state lithium-ion battery 400 may include any feature or characteristic as previously discussed with regard to the all-solid-state lithium-ion battery 220 shown in FIG. 2. FIG. 4A illustrates a hybrid solid electrolyte membrane 502, which may be the same as or include any feature or characteristic of the hybrid solid electrolyte membrane 202 of FIG. 2. FIG. 4B illustrates a cathode material 504 deposited on a first surface of the hybrid solid electrolyte membrane 502. The cathode material 504 may be the same as or include any feature or characteristic of the cathode material 204 of FIG. 2. FIG. 4C illustrates an anode material 506 deposited on a second surface of the hybrid solid electrolyte membrane 502 opposite the first surface. The anode material 506 may be the same as or include any feature or characteristic of the anode material 208 of FIG. 2.

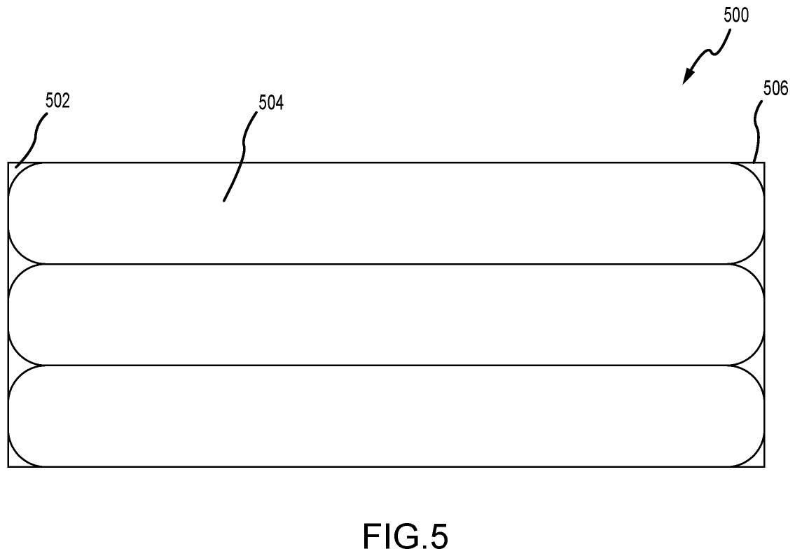

FIG. 5 is an illustration of an exemplary flexible all-solid-state lithium-ion battery 500 having a jelly roll cell configuration according to some examples of the present disclosure. The all-solid-state lithium-ion battery 500 may be include any feature or characteristic as previously discussed with regard to the all-solid-state lithium-ion battery 220 shown in FIG. 2. The all-solid-state lithium-ion battery 500 can include one or more battery cells 504. The battery cells 504 can be stacked together. The all-solid-state lithium-ion battery 500 can also include one or more dead space regions 502 located around the battery cells 504. For example, the dead space regions 502 can be located in gaps between the battery cells 504, or between gaps between the battery cells 504 and a housing 506. The dead space regions 502 may not contribute to the energy density of the all-solid-state lithium-ion battery 500. In some examples, the dead space regions 502 may be drastically reduced compared to conventional technologies due to the flexibility of the battery cells 504. For example, the flexible all-solid-state lithium-ion battery 500 may be characterized by a volume of dead space regions 502 of less than or about 25 vol. %, and may be characterized by a volume of dead space regions 502 of less than or about 15 vol. %, less than or about 10 vol. %, less than or about 7.5 vol. %, less than or about 5 vol. %. less than or about 4 vol. %, less than or about 3 vol. %, or less.

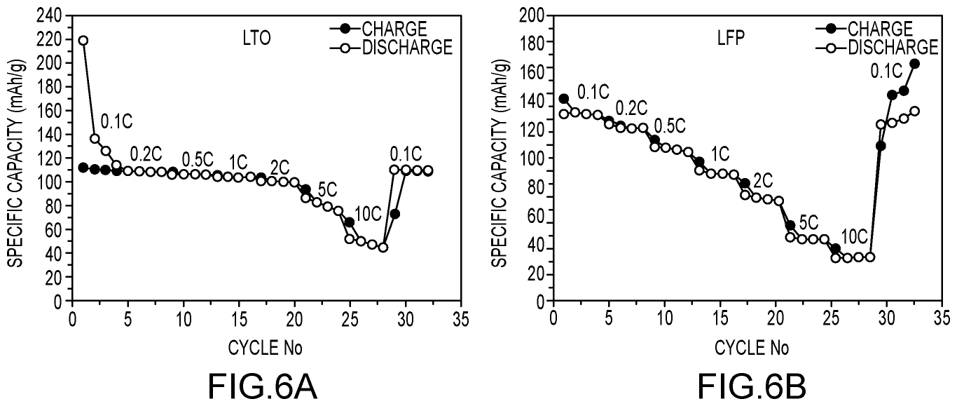

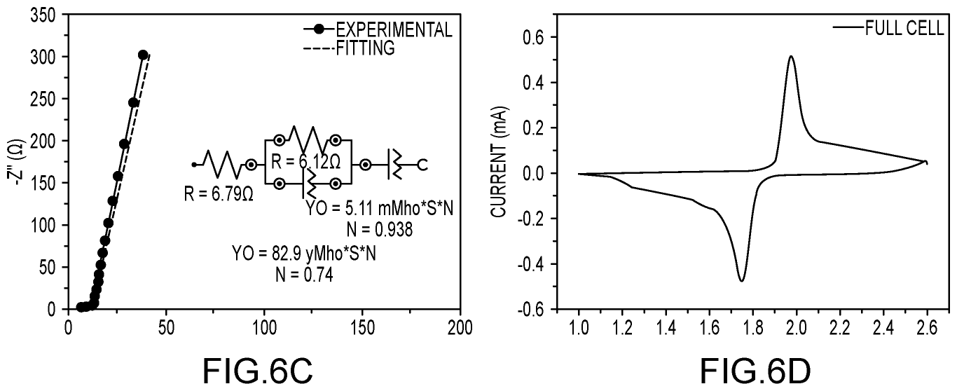

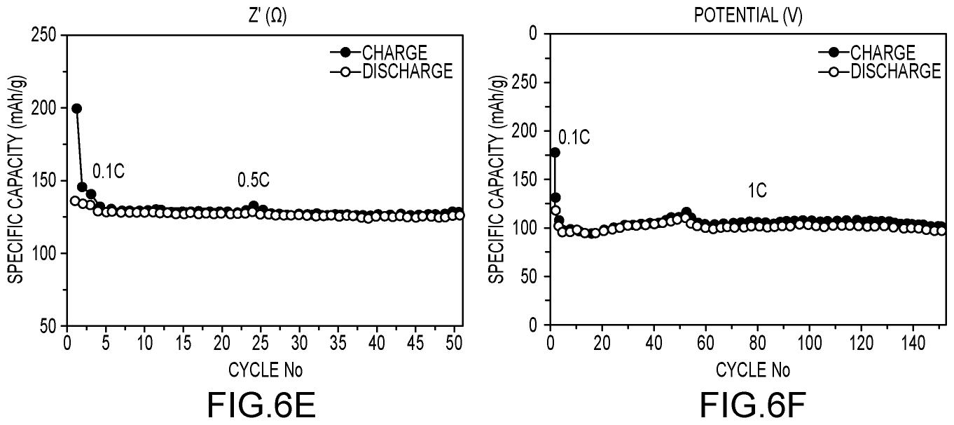

FIG. 6A-6F is an illustrative series of measurements that may be obtained from an exemplary flexible all-solid-state lithium-ion battery according to some examples of the present disclosure. FIG. 6A illustrates a performance comparison of lithium titanate (LTO)-based and Li-based electrodes at different current rates. FIG. 6B illustrates a performance comparison of lithium iron phosphate (LFP)-based and Li-based electrodes at different current rates FIG. 6C illustrates a Nyquist plot of the all-solid-state lithium-ion battery having a lithium iron phosphate (LFP)-based cathode, a hybrid solid electrolyte membrane electrolyte, and a lithium titanate (LTO)-based anode. FIG. 6D illustrates a cyclic voltammogram of the all-solid-state lithium-ion battery. FIG. 6E illustrates a cyclability graph of the all-solid-state lithium-ion battery at 0.5 C for 50 cycles. FIG. 6F illustrates a cyclability graph of the all-solid-state lithium-ion battery at 1 C for 150 cycles.

The electrochemical performance of components of an all-solid-state lithium ion-battery using LTO and LFP composite electrodes as cathode and anode can be determined using characterization techniques such as Field Emission Scanning Electron Microscopy

(FESEM), X-ray Powder Diffractometry (XRD), electrochemical impedance spectroscopy (EIS), chronoamperometry, or any other suitable characterization techniques. FIG. 6A and FIG. 6B illustrate the electrical performance of exemplary LTO and LFP composite electrodes with a hybrid solid electrolyte membrane at room temperature from 0.1 C to 10 C (where 1 C=170 mAh/g) between 1.0 to 3.0 V vs. Li+/Li and 2.5 to 4.0 V vs. Li+/Li, respectively. As shown, the LTO electrode may exhibit a rate performance with a capacity of about 120 mAh/g at 0.1 C. As shown, he LFP electrode may exhibit a maximum capacity of about 130 mAh/g, EIS studies can be conducted to understand the interfacial properties the all-solid-state lithium-ion battery. The Nyquist plot in FIG. 6C corresponds to an exemplary EIS study of an exemplary all-solid-state lithium-ion battery. The plot shows two distinct parts: one semicircle observed in high frequency range and an inclined line in low frequency range. An exemplary corresponding equivalent circuit is shown in FIG. 6C. The solution and charge resistance were found to be about 6.19 Ω and about 6.12 Ω, respectively. These low resistance values may indicate good interfacial connection between the hybrid solid electrolyte membrane and the electrodes. A good connection may improve performance of the all-solid-state lithium-ion battery.

FIG. 6D depicts an exemplary cyclic voltammogram the all-solid-state lithium-ion battery across a voltage range of about 1.0 to about 2.6 V at a scan rate of about 0.1 mV/s. Oxidation and reduction peaks for the all-solid-state lithium-ion battery can be observed at, for example, about 1.97 V and about 1.75 V respectively, with a peak potential difference of 0.22 V. Such a result may indicate diminished polarization and a low internal resistance of the all-solid-state lithium-ion battery. The galvanostatic charge-discharge (GCD) curves for all-solid-state lithium-ion battery can be measured across a voltage range of about 1.0 to about 2.6 V at about room temperature.

FIGS. 8E and 8F show exemplary charge storage performance at 0.5 C for 50 cycles and 1 C for 150 cycles. respectively. In embodiments, two formation cycles with 0.1 C current rates can be applied. The high and steady specific capacity of about 130 mAh/g can be observed at 0.5 C. Furthermore, when doubling the current, the specific capacity is stabilized up to about 100 mAh/g after 150 cycles. The overall performance of the all-solid-state lithium-ion battery with the hybrid solid electrolyte membrane even at high charge-discharge rate can be attributed to a uniform, homogeneous distribution of electrolyte particles in the hybrid solid electrolyte membrane, lower charge transfer resistance, high ionic conductivity and compatibility with electrodes.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms: furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X. Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone: B alone: C alone: A and B only: A and C only: B and C only: and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A flexible all-solid-state lithium-ion battery comprising:
a plurality of jelly roll battery cells, each jelly roll battery cell comprising:
a cathode comprising a first self-supporting lithium-based composite:
an anode comprising a second self-supporting lithium-based composite: and
a hybrid solid electrolyte membrane that is positioned between the cathode and the anode.

2. The flexible all-solid-state lithium-ion battery of claim 1, wherein each of the cathode and the anode further comprise a plurality of multi-walled carbon nanotubes.

3. The flexible all-solid-state lithium-ion battery of claim 1, wherein the anode includes a self-supporting lithium titanate multi-walled carbon nanotube composite, and wherein the cathode includes a self-supporting lithium iron phosphate multi-walled carbon nanotube composite.

4. The flexible all-solid-state lithium-ion battery of claim 1, wherein the hybrid solid electrolyte membrane is characterized by an ionic conductivity greater than or about 0.0005 Siemens per centimeter.

5. The flexible all-solid-state lithium-ion battery of claim 1, wherein the hybrid solid electrolyte membrane is characterized by a thickness of less than or about 30 microns.

6. The flexible all-solid-state lithium-ion battery of claim 1, wherein the all-solid-state lithium-ion battery is configured to operate without a current collector.

7. The flexible all-solid-state lithium-ion battery of claim 1, wherein the hybrid solid electrolyte membrane includes a poly(vinylidene fluoride-co-hexafluoropropylene) material.

8. A roll-to-roll method of manufacturing a jelly roll battery cell for a flexible all-solid-state lithium-ion battery, the method comprising:
depositing, on an upper side of a hybrid solid electrolyte membrane, a cathode material comprising a first self-supporting lithium-based composite:
annealing the cathode material:
depositing, on a lower side of the hybrid solid electrolyte membrane, an anode material comprising a second self-supporting lithium-based composite; and
annealing the anode material.

9. The method of claim 8, wherein each of the cathode material and the anode material further comprise a plurality of multi-walled carbon nanotubes.

10. The method of claim 8, wherein the anode material includes a self-supporting lithium titanate multi-walled carbon nanotube composite, and wherein the cathode material includes a self-supporting lithium iron phosphate multi-walled carbon nanotube composite.

11. The method of claim 8, wherein the hybrid solid electrolyte membrane is characterized by an ionic conductivity greater than or about 0.0005 Siemens per centimeter.

12. The method of claim 8, wherein the hybrid solid electrolyte membrane is characterized by a thickness of less than or about 30 microns.

13. The method of claim 8, wherein:
depositing the cathode material comprises directly coating a slurry of the cathode material onto the upper side of the hybrid solid electrolyte membrane, and
depositing the anode material comprises directly coating a slurry of the cathode material onto the lower side of the hybrid solid electrolyte membrane.

14. The method of claim 8, wherein the hybrid solid electrolyte membrane includes a poly(vinylidene fluoride-co-hexafluoropropylene) material.

15. An electrode for an all-solid-state lithium-ion battery comprising:
a self-supporting lithium-based composite that is configured to be wet coated on a hybrid solid electrolyte membrane and annealed.

16. The electrode of claim 15, further comprising:
a plurality of multi-walled carbon nanotubes.

17. The electrode of claim 16, wherein the electrode includes at least one material selected from a group comprising: (i) a self-supporting lithium titanate multi-walled carbon nanotube composite, and (ii) a self-supporting lithium iron phosphate multi-walled carbon nanotube composite.

18. The electrode of claim 15, wherein the hybrid solid electrolyte membrane is characterized by an ionic conductivity greater than or about 0.0005 Siemens per centimeter.

19. The electrode of claim 15, wherein the hybrid solid electrolyte membrane is characterized by a thickness of less than or about 20 microns.

20. The electrode of claim 15, wherein the hybrid solid electrolyte membrane includes a poly(vinylidene fluoride-co-hexafluoropropylene) material.
